(19) United States
(12) Patent Application Publication
(10) Pub. No.: US 2004/0006557 A1
(43) Pub. Date: Jan. 8, 2004

(54) Technique for effective management of directory information

(76) Inventors: Nathan B. Baker, Tigard, OR (US); Gary E. Henry, Tigard, OR (US); Timothy A. Timmins, Tigard, OR (US)

Correspondence Address: Alex L. Yip, Kaye Scholer LLP, 425 Park Avenue, New York, NY, 10022, US

(21) Appl. No.: 10/190,782

(22) Filed: Jul. 8, 2002

(51) Int. Cl. G06F 17/30

(52) U.S. Cl. 707/3; 707/10

(57) ABSTRACT

When a user calls an information assistance service to request a desired listing, an operator answering the call may search multiple data sources for the desired listing. Such data sources may include, e.g., a contacts folder associated with the user which is maintained by the information assistance service for the user, a public national directory database and an enterprise directory database. When a listing satisfying the request is returned from the search, the source of the listing is identified. For example, if it is determined that the returned listing comes from a source other than the contacts folder, the listing may be incorporated into the contacts folder in accordance with the invention. The manner in which the listing is incorporated into the contacts folder may depend on a user preference.

### FIELD OF THE INVENTION

The invention relates to a data management technique, and more particularly to a technique for managing multiple directories in an information assistance service.

### BACKGROUND OF THE INVENTION

It is a common experience to use, e.g., a wireline telephone, a wireless telephone or other mobile device, to call an operator for information assistance. In a typical information assistance call, a caller identifies to the operator the name and address (sometimes city or area code) of a party whose telephone number is desired. In response, the operator locates the desired destination number using, e.g., a computer database. The caller may then be afforded an option to be connected to the destination number without the need of first terminating the information assistance call.

After exercising such an option, the user may be provided with enhanced information assistance services where the connection to the destination number may be monitored. Examples of such enhanced services are described, for instance, in U.S. Pat. No. 5,873,032 issued Feb. 16, 1999 to Cox et al. In accordance with one such enhanced service, when a busy or ring-no-answer condition is encountered in the connection to the destination number, a voice server intervenes, informs the user of the unsuccessful connection, and provides the user with a menu of options. A first option may be to receive the destination number in an automated voice by pressing a “2” key; a second option may be to return to an operator for further assistance by pressing a “*” key; etc.

### SUMMARY OF THE INVENTION

Certain disadvantages associated with the prior art information assistance service have been recognized. For instance, the information (e.g., the desired destination number) provided by the prior art service to a user is on a call-by-call basis. That is, the prior art service fails to provide a user with access to the information previously requested by the user from earlier information assistance calls. In addition, if the user wants to record the information for future use which is provided by the prior art service, e.g., in automated voice, the user needs to record it by hand. This proves to be, at best, inconvenient for wireless telephone or mobile device users, especially for those who are driving.

In accordance with the invention, an information assistance service maintains for a user a data source, e.g., a contacts folder(s) (also known as a “private directory”), associated with the user, which contains contacts information. The user may have predesignated access rights to the contacts folder, e.g., rights to view, modify, administer and/or delete the content of the contacts folder. The user may access the contacts folder by calling the information assistance service, where an operator may perform actions on the contacts folder according to the user's instructions. In that case, the operator acts as an agent or alter ego of the user. Alternatively, the user may directly access the contacts folder through a communications network, e.g., the Internet, without the agency of the operator.

After the information assistance service receives, from the user, a request for directory information concerning a desired party, multiple data sources including, e.g., the contacts folder associated with the user, public directory databases, and enterprise directory databases are simultaneously or sequentially searched in accordance with the invention. A search result satisfying the request is then selected. Based on a source indicator associated with the search result, the data source to which the search result is attributed is identified. If the identified data source is different than the contacts folder, selected data from the search result may be incorporated into the contacts folder, subject to the predesignated access rights. The manner in which the selected data is incorporated into the contacts folder may be specified by the user in a profile record containing, e.g., user preferences, which may also be maintained in the information assistance service.

Thus, with the invention, desired directory information provided by an information assistance service may be advantageously incorporated in a specified data location, e.g., the contacts folder, which the user can conveniently access later.

### BRIEF DESCRIPTION OF THE DRAWING

Further objects, features and advantages of the invention will become apparent from the following detailed description taken in conjunction with the accompanying drawing showing illustrative embodiments of the invention, in which:

FIG. 1 illustrates a communications system including information/call centers in accordance with the invention;

FIGS. 2A and 2B are block diagrams of components of the communications system of FIG. 1;

FIG. 3 illustrates a user profile gateway in an information/call center connected to a profile manager managing user profiles;

FIG. 4 illustrates a user profile record in accordance with the invention;

FIG. 5 illustrates a Login graphical user interface (GUI) for providing a personalized information service;

FIG. 6 illustrates a Home GUI for providing the personalized information service;

FIG. 7 illustrates the content of a contacts folder maintained in the personalized information service;

FIG. 8 illustrates a GUI particularly useful for searching multiple data sources for directory information concerning a desired party; and

FIG. 9 is a flow chart depicting a process for incorporating a desired listing from one data source into another.

### DETAILED DESCRIPTION

The invention is directed to a technique for management of directory information, e.g., contacts information. It is common to use personal information managers (PIMs) to organize contacts information in a directory. Well known PIMs include, e.g., hand-held devices such as personal digital assistants (PDAs) and wireless communicators; and computer devices such as notebook, laptop and desktop computers running software applications such as Microsoft Outlook, Outlook Express, Goldmine, Symantec Act!, Lotus Organizer and Lotus Notes. Other PIMs may include proprietary PIM systems and applications. In this illustrative embodiment, a PIM user subscribes to a personalized information service, and from time to time synchronizes his/her PIM directory with a database of the service provider.

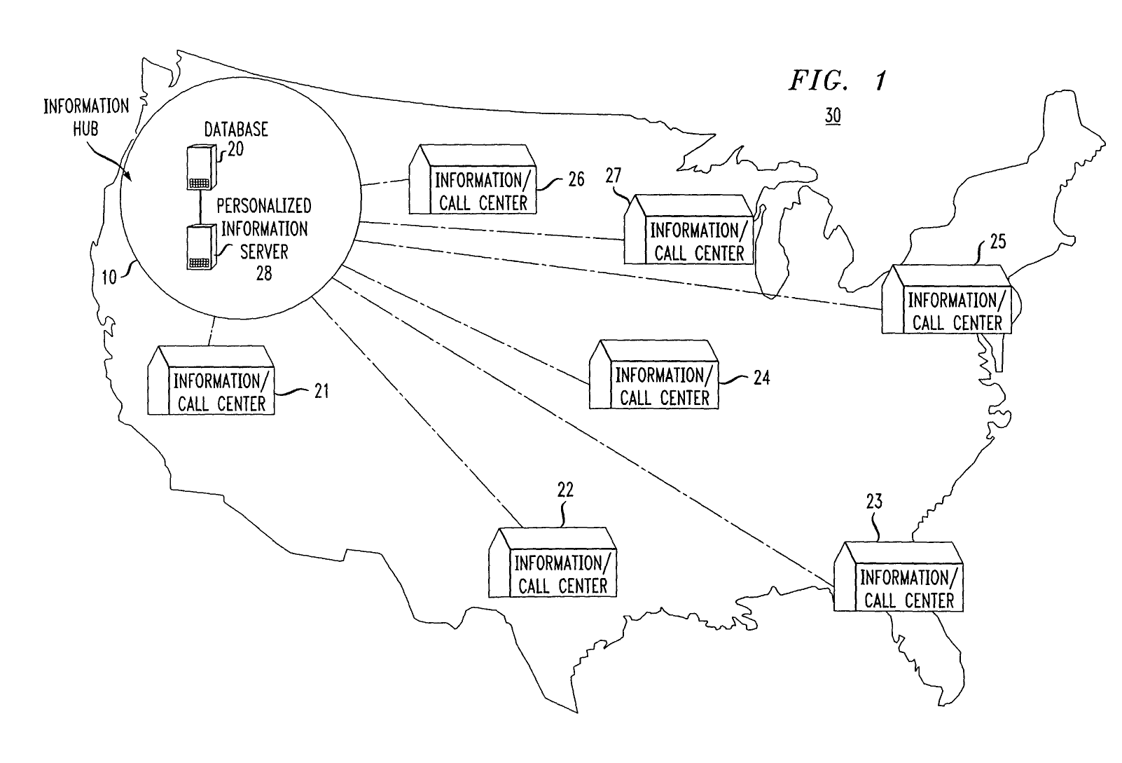

FIG. 1 illustrates a communications system embodying the principles of the invention for providing, inter alia, the personalized information service. This communication system includes wide area network (WAN) 30 covering an extensive area. WAN 30 may be an Internet-based network such as the World Wide Web or a private intranet based network. WAN 30 connects operators dispersed throughout a wide coverage area in information/call centers 21 through 27. It should be noted that the term “operators” used herein broadly encompasses entities that are capable of providing assistance in a telecommunication environment, including without limitation human operators, voice response/recognition capabilities, web-/WAP-enabled operator services, and other automated and electronic access. Each of information/call centers 21 through 27 covers one or more regional coverage areas. One or more information hubs 10 are also included in WAN 30. An information hub 10 includes one or more personalized information servers 28 which are accessible by the operators in the system, and one or more databases 20 in which subscribers' information, and contacts and other folders (e.g., appointment folders for storing calendar information) may be stored and maintained. Such information and folders may also be stored locally at one or more of the information/call centers.

A user of the personalized information service may want to create multiple contacts folders for different purposes. For example, they may include a personal contacts folder containing personal directory information, and a business contacts folder containing business directory information. With the personalized information service, a contacts folder may be created and maintained (1) through the Internet or other network or communications means directly, (2) through an operator indirectly, and/or (3) using a PIM. In case (3), by running a synchronization engine, the user may update any directory information which has been changed (added, edited or deleted) in a PIM data source in the corresponding contacts folder, and vice versa.

In case (2), the user may access a contacts folder through communications with an operator at an information/call center via telecommunication media, e.g., wireless telephone, wireline telephone, voice over Internet protocol (VoIP), PDA, VPN, etc. The operator, as explained in more detail below, is generally provided with web browsing capabilities, telephone facilities as well as fully-featured operator user interface applications which facilitate the searching, retrieval and administering of database 20 through server 28. It is well understood that operators generally receive and respond to requests for directory assistance, information and communications services.

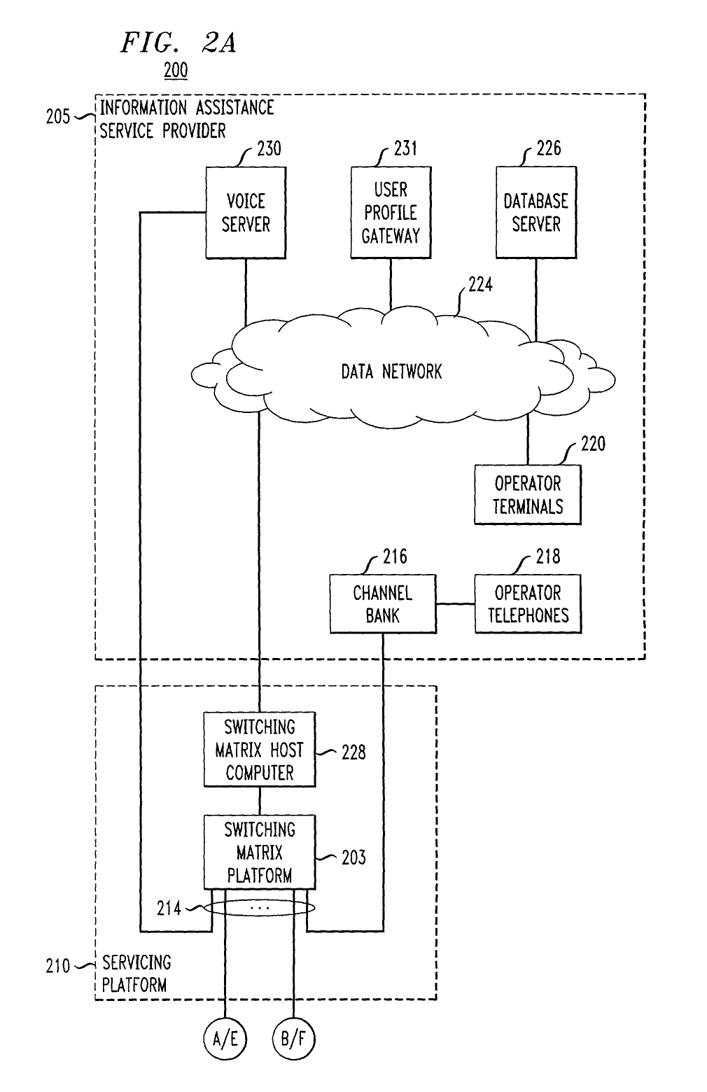

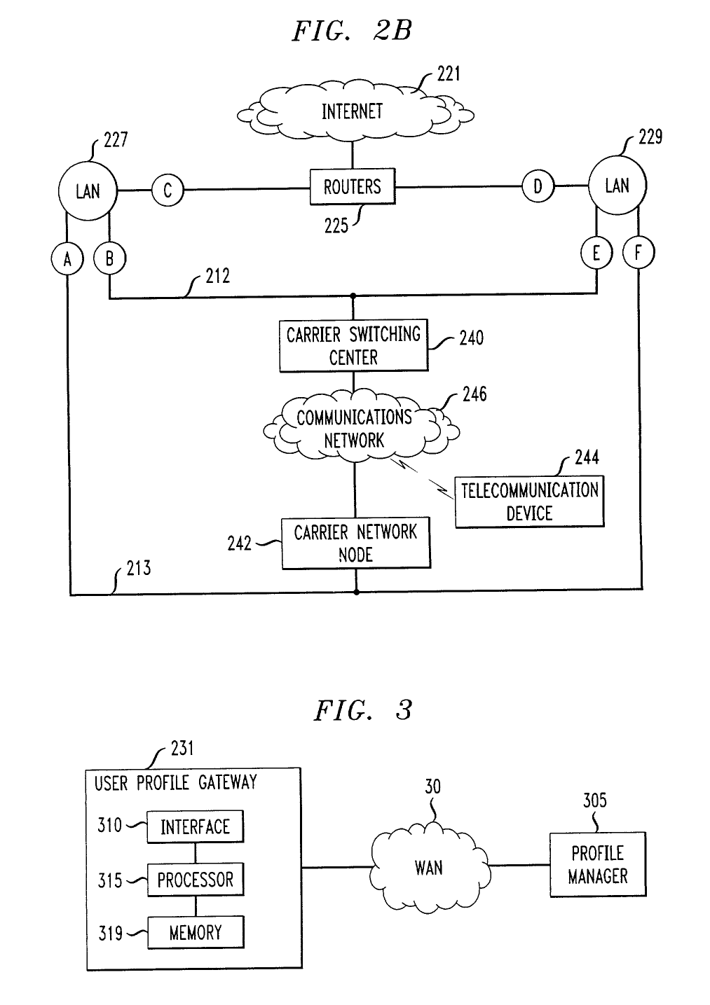

Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203 which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a video display unit and a keyboard with associated dialing pad. Operator terminals 220 are connected over data network 224 to one or more database server(s) 226 (although only one is shown here). Database server 126 provides access to, among others, directory information from multiple sources. Database server 226 enables the operator to search directory information not just by name and address (sometimes city or area code) of a desired party, but also by type of goods/services and/or geographical region of a desired entity.

Data network 224 further connects to voice server 230, user profile gateway 231, and switching matrix host computer 228, which in turn is connected to switching matrix platform 203 via a data link. Data network 224 includes, but is not limited to, local area network (LAN) 227, best seen in FIG. 2B. LAN 227 may connect to other similar remote LANs 229 to form WAN 30 in FIG. 1. LANs 227 and 229 are connected to one another and to Internet 221 via routers 225.

A user's telephone, computer, PDA or other telecommunication device 244 communicates via communications network 246 which is connected to carrier network node 242 and carrier switching center 240. T1 voice links 212 provide connection between the information/call center's switching matrix platform 203 and carrier's switching center 240, through which incoming information service calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could also be a physically distinct component. If the outgoing call is being placed over a different network than that on which the incoming call was received, a second data connection to the outgoing network will be established.

The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on center 200 and platform 203 for each corresponding function.

Voice server 230 is connected via data network 224 to computer 228 (to which it acts as a slave processor) and via one or more T1 links to switching matrix platform 203. Each voice server 230 when more than one is employed in information/call center 200, connects to switching matrix platform 203 via a separate T1 link. Voice server 230 is employed to play the constantly repeated parts of an operator's speech, namely, the various greetings and signoffs (or closings), the caller's desired telephone number where requested, and possibly other information. At appropriate stages in a call progression, switch matrix host computer 228 initiates a voice path connection between voice server 30 and switching matrix platform 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state. Voice server 230 may also contain a voice recognition device for receiving verbal input from a party connected to the voice server.

Users of a particular telephone carrier may dial, speak or otherwise communicate predetermined access digits, access codes or retail numbers, or input a predetermined address or a URL established for information assistance by that company. The instant example assumes that the user dials, e.g., “411,” “*555,” “555-1212,” “1-800-555-1212,” “00,” or other designated access numbers. The participating telephone company's own switching system will then reroute the call to information/call center 200 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes are utilized, such as skills-based routing or a priority scheme for preferred callers. The queue is maintained by switching matrix host computer 228.

As mentioned before, a user may create, maintain or access one or more contacts folders (or other folders such as a personal or company calendar folders) via the Internet or other network or communications means, or through an operator who in turn may create, maintain or access the folder on behalf of the user. In this illustrative embodiment, two contacts folders associated with the user, e.g., “My Contacts” and “Company Contacts” folders, are maintained and stored in database 20.

When the user uses telecommunication device 244, e.g., a wireless telephone, to call an operator at a designated access number for information assistance, the call is routed to, say, information/call center 200. After receiving the call, center 200 checks any personal profile record associated with the user. In general, a personal profile record is identified by a user's telephone number and maintained by a profile manager described below. Referring back to FIG. 2A, an information assistance call is received by switching matrix platform 203 in center 200. In a well known manner, platform 203 derives, from the call set-up signals associated with the call, an automatic number identification (ANI) indicating the telephone number of the communication device from which the call originates. Switching matrix host computer 228 then requests any user profile record identified by such an ANI from gateway 231 connected to data network 224.

Referring also to FIG. 3, gateway 231 receives the profile record request including the ANI from data network 224 through interface 310. In response to such a request, processor 315 searches memory 319 for the profile record identified by the ANI. It should be noted at this point that all profile data is input and updated through profile manager 305. Copies of the profile data are distributed by manager 305 to the profile gateways in various information/call centers through WAN 30. In this illustrative embodiment, a master copy of the profile records is kept at manager 305. For example, profile gateway 231 initially forwards requests for new profile records to manager 305, and caches copies of the requested profile records from manager 305 in local memory 319 for rapid, subsequent retrieval of the profile records. Memory 319 here generically includes disks, caches, and volatile and nonvolatile memories. When a particular profile record in gateway 231 is updated at manager 305, the latter notifies gateway 231 that the particular profile record has expired.

Thus, continuing the above example, if processor 315 determines that the requested profile record cannot be found in memory 319 or the requested profile record has expired, processor 315 forwards the profile record request to manager 305 through interface 310. In response, manager 305 provides to gateway 231 any latest profile record identified by the ANI. Otherwise, processor 315 retrieves from memory 319 any available, unexpired profile record identified by the ANI.

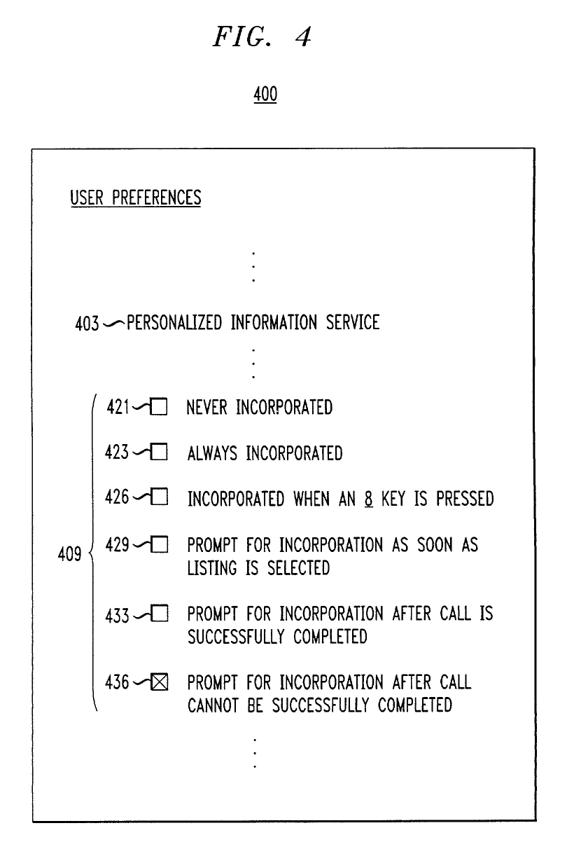

FIG. 4 illustrates profile record 400 associated with the user in this instance. Record 400 contains user preferences including information concerning the user's subscription to enhanced services, e.g., the aforementioned personalized information service. Record 400 is updated from time to time when one or more user preferences are changed, and in particular each time when the user subscribes to a new enhanced service or cancels an enhanced service subscription.

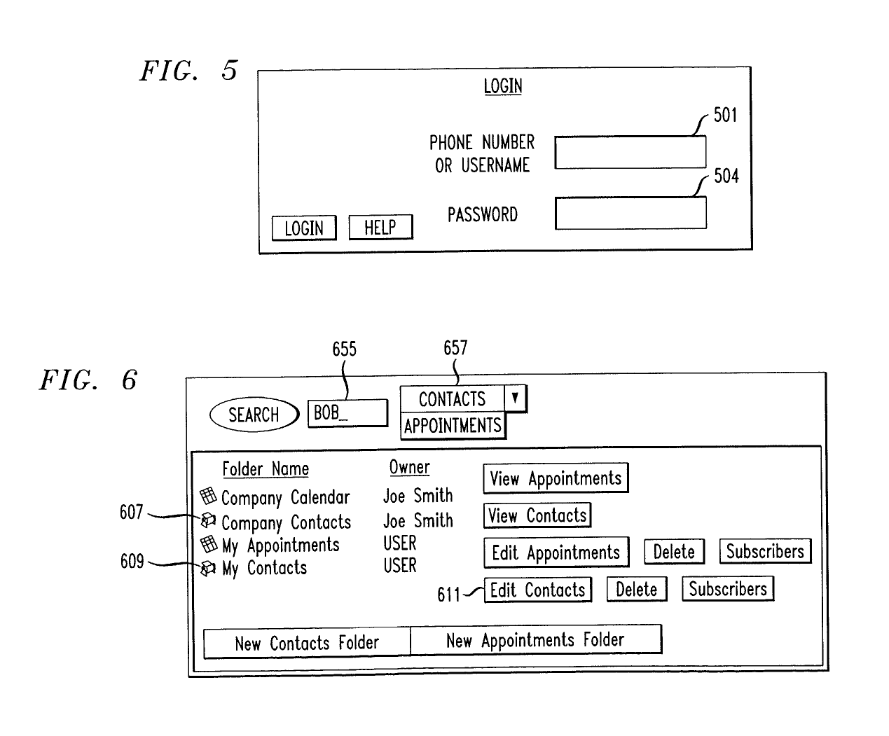

Knowing from record 400 that the user is a subscriber to the personalized information service, computer 228 communicates the received ANI to personalized information server 28 through WAN 30 (or alternatively Internet 121). In response, server 28 presents a Login graphical user interface (GUI) on terminal 120, at which an operator is currently attending to the user's information assistance call. FIG. 5 illustrates such a GUI where the operator is prompted to enter the user's phone number or username to identify the user, and a password to verify that the user is authorized to access the personalized information service. It will be appreciated that other user identifying information, e.g., a personal identification number (PIN), his/her mother's maiden name, etc. may be used for verification purposes as well.

It should be noted at this point that the user identification and password are established beforehand through a registration process. For example, to subscribe to the personalized information service, the user can call an operator at the designated access number. As part of the registration, the operator enters at a user data web page on server 28 the user identifying information including username, password, and telephone number of the particular telecommunication device, e.g., a wireless telephone in this instance, which the user would use to call the information assistance service in the future. It is particularly advantageous to use such a phone number (also known as a mobile directory number (MDN) in the case of a wireless phone number) to identify the user since, as described before, the calling number would be automatically captured as an ANI at information/call center 200 when the user calls.

Thus, the ANI of the user is automatically provided in entry 501 of the Login GUI by server 28, thereby obviating the need of the operator's eliciting from the user, and entering, the required phone number or username. (In the event that such an ANI is not automatically available, or where the user is accessing the subject service from an unknown point or the operator suspects that the user calls from a phone number other than the registered phone number, the operator may verify/obtain the necessary identifying information with/from the user.) At entry 504, the operator enters the password provided by the user to complete the login process. The login information is then transmitted to server 28, where it checks the aforementioned user data web page to verify the received ANI and password. After they are verified, server 28 identifies from the user data web page all of the folders including contacts folders and appointments folders associated with the received ANI, and any user's access rights thereto. For example, for each folder, the user may have the predesignated rights to view, edit, administer, and/or delete the folder. Server 28 presents to terminal 120 a Home GUI, listing all such folders associated with the ANI and thus the user.

FIG. 6 illustrates such a Home GUI, which lists, among others, contacts folders 607 and 609 designated “Company Contacts” and “My Contacts,” respectively. The operator can access each contacts folder, and manage the contacts information in the folder for the user, subject to the user's access rights thereto. For example, the user in this instance has the predesignated right to view the content of Company Contacts folder 607 only. On the other hand, he/she has the additional right to edit the content of My Contacts folder 609.

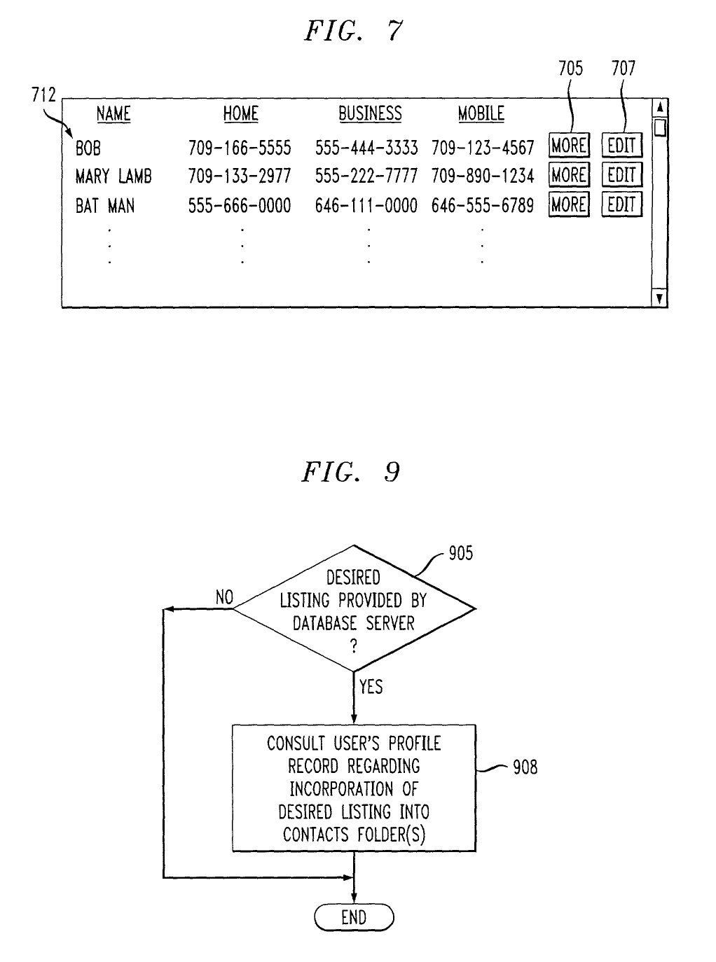

FIG. 7 illustrates a GUI showing the content of My Contacts folder 609 when, say, Edit Contacts option 611 is selected. As shown in FIG. 7, for each contact, e.g., Bob, his/her name, home phone number, business phone number and mobile phone number, if any, although additional information concerning the contact, e.g., his/her postal and electronic mail addresses, may be available but is not displayed for lack of room. For that reason, a More option, e.g., option 705, is provided for selection to present the additional information on a separate screen. In addition, for each contact an Edit option, e.g., option 707, is provided to edit the contact information.

Referring back to FIG. 6, a search engine is provided on the Home GUI to search for a listing of a desired contact. For example, the operator may specify at entry 655 a search term (e.g., Bob), and select at entry 657 the type of folder (e.g., contacts) in which the search term is to be found. Thus, by using such a search engine, an informal request without much information, such as “I need to reach Bob” and “I want to talk to the sales manager at ABC Corporation” is sufficient for the operator to locate the requested contact information in a contacts folder. After initiating the search by clicking on the “Search” button, any listing satisfying the search query is highlighted. In this instance, a search on the name “Bob” in a contacts folder uncovers listing 712 in the GUI of FIG. 7.

However, in this illustrative embodiment, the operator may elicit from the user more specific data about the desired contact, e.g., Bob's full name, to also search other databases in case the desired contact information cannot be found in any contacts folders associated with the user. Such other databases may include public national directory databases and other public directory databases, enterprise directory databases (e.g., corporation directory databases, and university directory databases), etc., accessible by database server 226. To that end, GUI 880 in FIG. 8 is designed for the operator to perform such a combined search. As shown in FIG. 8, section 885 of GUI 880 corresponds to the Home GUI of FIG. 6, which allows the operator to manage contacts and appointments folders for the user as described before. In addition, search section 882 provides the interface for the operator to search not only the contacts folders associated with the user, but also in this instance a public national directory database and enterprise directory databases accessible by database server 226, for information concerning a desired party.

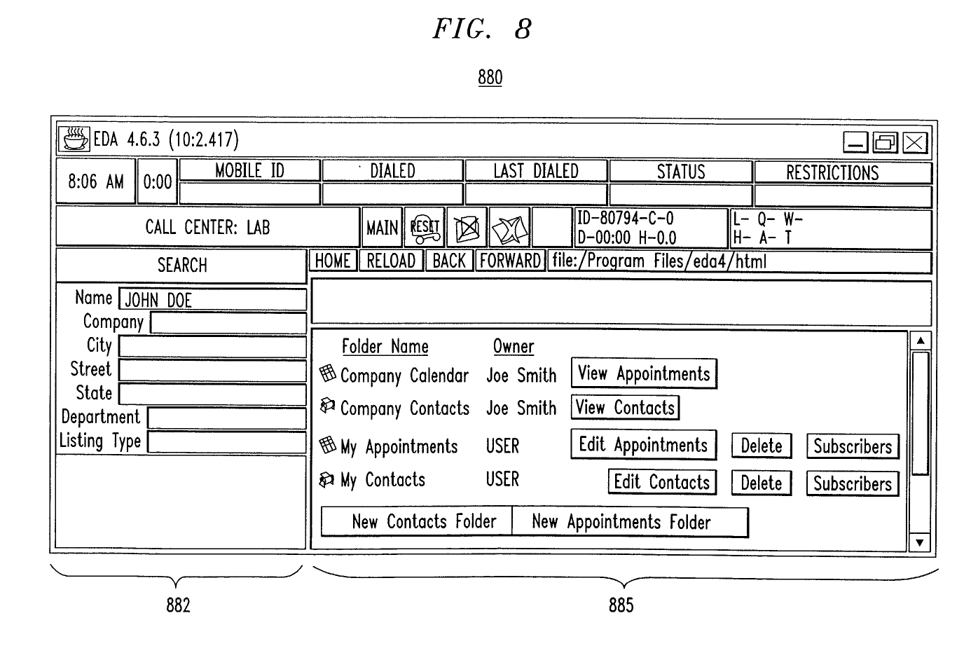

Thus, in this example, when the user requests a listing of a desired party, say, John Doe, the operator invokes GUI 880 on terminal 220. The operator enters at search section 882 the name John Doe and any other information provided by the user to the best of his/her ability such as the name of the company at which John Doe works, his or his company's address, etc. In response, no, or one or more search results meeting the user's request are returned from database server 226 accessing a public national directory database and enterprise directory databases in this instance, and/or from personalized information server 28 accessing folders 607 and 609 associated with the user. Each returned listing in this instance includes a source indicator indicating its provider, i.e., database server 226 or personalized information server 28. If multiple John Doe listings are returned, the operator in a conventional manner discusses the listings with the user to ascertain the desired John Doe listing. When the desired John Doe listing is ascertained and selected by the operator for later possible connection to the listed telephone number for the user, host computer 128 determines whether the desired listing was provided by database server 226 based on the source indicator therein, as shown at step 905 in FIG. 9. If so, computer 128 at step 908 consults the user's profile record (i.e., profile record 400) regarding incorporation of the desired listing into one or more contacts folders associated with the user before the process ends.

For example, section 409 in profile record 400 includes options selectable by the user to incorporate the above desired listing into My Contacts folder 609 in this instance, stemming from the fact that the user here has the aforementioned rights to edit My Contacts folder 609 only but not Company Contacts folder 607. Otherwise, if the user has the rights to edit multiple contacts folders, the folder involved in the incorporation needs to be specified by the user beforehand or upon request. In any event, without loss of generality, any user selection of option 421 indicates that the user never wants to incorporate any such desired listing into folder 609. Any user selection of option 423 indicates that the user always wants to incorporate any such desired listing into folder 609. In that case, the incorporation is automatically performed upon selection of the desired listing. In general, the incorporation is carried out pursuant to a predetermined protocol whereby the desired listing when incorporated would be properly formatted in folder 609.

Any user selection of option 426 indicates that the user wants to incorporate any such desired listing into folder 609 when he/she, without being prompted, presses a predetermined key on the telephone, e.g., the “8” key. The depression of the predetermined key is ascertained when the DTMF signal associated with the key is detected by a DTMF signal detector in platform 203 onto which the user connection (also known as an “inbound channel”) terminates.

Any user selection of option 429 indicates that the user wants to be prompted for incorporation of any such desired listing into folder 609 upon selection of the listing. In that case, computer 228 may cause voice server 230 to request the caller, through the inbound channel, to press a predetermined key on the telephone (e.g., the “8” key) if he/she wants to incorporate the desired listing into folder 609. It should be noted that option 429 is the default option here. As such, when the user fails to select any option in section 409, computer 228 assumes that option 429 has been selected.

Any user selection of option 433 indicates that the user wants to be prompted for incorporation of any such desired listing into folder 609 only after a call to the listed telephone number is successfully completed. On the other hand, any user selection of option 436 indicates that the user wants to be prompted for incorporation of any such desired listing into folder 609 only after a call to the listed telephone number cannot be successfully completed, e.g., when a busy signal, ring-no-answer condition or communication problem is encountered during the call.

Let's assume that the user in this instance has selected option 436, which selection may have been made by the user during his/her registration with the personalized information service. Continuing the above example, upon learning the desired John Doe listing, the operator offers the user an option to be connected to the desired John Doe telephone number. If the user exercises such an option, the operator then initiates an outgoing call for the user by seizing an outgoing voice channel from a T1 communication link 214 and outdialing the desired telephone number. Outdialing is a function of platform 203, whereby platform 203 transmits the desired telephone number after it is entered. Host computer 228 is notified of the outgoing call and automatically instructs platform 203 to apply a CPA therein to the outbound channel and a DTMF receiver to the inbound channel after outdialing. Such a CPA is sensitive to, and capable of identifying, telephone connection status conditions and signals including ring tone, busy, reorder, PBX intercept, SIT intercept, vacant code, reorder-SIT, no circuit LEC, reorder-carrier, no circuit-carrier, dial tone, continuous on tone, and silence. Platform 203 afterwards connects the user on the inbound channel to the outgoing call on the outbound channel.

The CPA monitors the outgoing call on the outbound channel for a predetermined number of rings, a predetermined amount of time, or until a specified connection status is detected. A successful call, in which the destination telephone is answered, is recognized by platform 203. Illustratively, platform 203 identifies a successful call by detecting, on the outbound channel, the bit transition that occurs when the destination telephone converts from an on-hook status to an off-hook status. The detection of a successful call is relayed to host computer 228 by platform 203.

When an outgoing call is successfully completed, platform 203 remains passively connected to the call. When the destination telephone is disconnected, platform 203 detects another bit transition indicating that the destination telephone changed from off-hook to on-hook. In response, platform 203 removes the application of the CPA on the outbound channel.

If the user disconnects, whether before or after the called party disconnects, the user's call is broken down and the connection between the user and platform 203 is terminated. If the user does not disconnect from system 100 within a configurable period of time after the called party disconnects, an information assistance menu is presented by voice server 230 to user telecommunication device 244. Such a menu may include options selectable by pressing specified keys on device 244. Alternatively, the user's selection is spoken into device 244, which is received and recognized by a voice recognition device in voice server 230. In this instance, pressing the “#”key enables the user to hear a recitation of the desired destination telephone number provided by voice server 230 through the inbound channel; pressing the “*” key enables the user to be re-connected to an operator, etc. Had the user selected aforementioned option 433 in profile record 400, the user would be prompted to press, say, the “8” key to have the desired John Doe listing incorporated in folder 609 as well.

Otherwise, if the aforementioned outgoing call cannot be successfully completed, e.g., the call status condition of the outgoing call identified by the CPA as a busy signal, platform 203 terminates the outgoing call by releasing the outbound channel, with the inbound channel intact. A second information assistance menu is then presented by voice server 230 to user telecommunication device 244. Compared with the first menu described above, this second menu here includes three additional options, namely, an option to have platform 203 attempt the same destination telephone number again by pressing the “2” key, another option to record a message for later delivery to the destination party by pressing the “1” key, and yet another option to incorporate the desired John Doe listing into folder 609 by pressing, say, the “8” key, in accordance with the user selection of option 436 in profile record 400 in this instance.

The second information assistance menu may similarly be presented to user communication device 244 in the event that the call status condition of the outgoing call is detected by the CPA in platform 203 as a ring-no-answer condition. Under that condition, it is desirable to allow sufficient time for the destination party to answer the call, but yet also provide the user with the second menu, other than simply waiting continuously for an answer. At the same time, the ring tone on the outbound channel may be temporarily muted or its volume is temporarily reduced. In addition, voice server 230 may vocally communicate, through the inbound channel, the second menu while the user is waiting. If the user chooses to do nothing and wait, the ring tone continues until the destination telephone is answered, or the user disconnects.

In the event that the call status condition of the outgoing call is identified as a communication problem, e.g., reorder, PBX intercept, SIT intercept, vacant code, reorder-SIT, no circuit LEC, reorder-carrier, no circuit-carrier, dial tone, continuous on tone, or silence, voice server 230 informs the user of the communication problem. In addition, voice server 230 may present to user communication device 244 the second information assistance service menu described above.

The foregoing merely illustrates the principles of the invention. It will thus be appreciated that those skilled in the art will be able to devise numerous other arrangements which embody the principles of the invention and are thus within its spirit and scope.

For example, information/call center 200 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for use in an information assistance service, comprising:
receiving from a user a request for directory information concerning a desired party;
in response to the request, searching a plurality of data sources including one or more particular data sources to which the user has predesignated access rights;
selecting a search result satisfying the request;
based on a source indicator associated with the search result, identifying a data source to which the search result is attributed; and
when the identified data source is different than the one or more particular data sources, incorporating selected data from the search result into one of the one or more particular data sources, subject to the predesignated access rights.

2. The method of claim 1 wherein the predesignated access rights include rights to modify data in the one or more particular data source.

3. The method of claim 1 wherein the selected data includes a telephone number of the desired party.

4. The method of claim 1 wherein the plurality of data sources include a public directory database.

5. The method of claim 1 wherein the plurality of data sources include an enterprise directory database.

6. The method of claim 1 wherein the one or more particular data sources are managed for the user by the information assistance service.

7. The method of claim 1 wherein the one or more particular data sources are accessible through a communications network.

8. The method of claim 7 wherein the communications network includes at least part of the Internet.

9. The method of claim 1 wherein the one or more particular data sources are updated using a personal information manager (PIM).

10. A method for managing a data source for a user in an information assistance service, comprising:
receiving from the user a request for information through a communication connection;
obtaining desired information responsive to the request;
determining that the desired information is not included in the data source; and
incorporating the desired information into the data source in a selected manner, the selected manner being specified by the user.

11. The method of claim 10 wherein the communication connection is established by the user using a communication device.

12. The method of claim 11 wherein the selected manner is indicated in a record, the method further comprising locating the record based on an identifier associated with the communication device.

13. The method of claim 12 wherein the communication device includes a telephonic device, and the identifier includes a telephone number.

14. The method of claim 13 further comprising receiving signals in establishing the communication connection, wherein the signals contain data concerning the telephone number.

15. The method of claim 14 wherein the data includes an automatic number identification (ANI).

16. The method of claim 10 wherein the selected manner includes automatically incorporating the desired information into the data source.

17. The method of claim 10 wherein the selected manner includes delaying an incorporation of the desired information into the data source until the user causes a selected signal to be transmitted through the communication connection, indicating an initiation of the incorporation.

18. The method of claim 17 wherein the selected signal includes a voice command.

19. The method of claim 17 wherein the selected signal is generated using a telephonic device.

20. The method of claim 19 wherein the selected signal includes a DTMF signal.

21. The method of claim 10 wherein the desired information includes a telephone number of a desired party.

22. The method of claim 21 further comprising initiating a communication call through a second communication connection to a communication device associated with the telephone number.

23. The method of claim 22 wherein the selected manner includes offering an incorporation of the desired information into the data source after the communication call is successfully completed.

24. The method of claim 22 wherein the selected manner includes offering an incorporation of the desired information into the data source when a busy condition of the second communication connection is determined.

25. The method of claim 22 wherein the selected manner includes offering an incorporation of the desired information into the data source when a ring-no-answer condition of the second communication connection is determined.

26. The method of claim 22 wherein the selected manner includes offering an incorporation of the desired information into the data source when it is determined that the second communication connection has a communication problem.

27. A system for use in an information assistance service, comprising:
an interface for receiving from a user a request for directory information concerning a desired party;
a mechanism responsive to the request for searching a plurality of data sources including one or more particular data sources to which the user has predesignated access rights, a search result satisfying the request being selected;
a processor for identifying, based on a source indicator associated with the search result, a data source to which the search result is attributed; and
a server for incorporating selected data from the search result into one of the one or more particular data sources, subject to the predesignated access rights, when the identified data source is different than the one or more particular data sources.

28. The system of claim 27 wherein the predesignated access rights include rights to modify data in the one or more particular data sources.

29. The system of claim 27 wherein the selected data includes a telephone number of the desired party.

30. The system of claim 27 wherein the plurality of data sources include a public directory database.

31. The system of claim 27 wherein the plurality of data sources include an enterprise directory database.

32. The system of claim 27 wherein the one or more particular data sources are managed for the user by the information assistance service.

33. The system of claim 27 wherein the one or more particular data sources are accessible through a communications network.

34. The system of claim 33 wherein the communications network includes at least part of the Internet.

35. The system of claim 27 wherein the one or more particular data sources are updated using a PIM.

36. A system for managing a data source for a user in an information assistance service, comprising:
an interface for receiving from the user a request for information through a communication connection;
a mechanism for obtaining desired information responsive to the request;
a processor for determining that the desired information is not included in the data source; and
a server for incorporating the desired information into the data source in a selected manner, the selected manner being specified by the user.

37. The system of claim 36 wherein the communication connection is established by the user using a communication device.

38. The system of claim 37 wherein the selected manner is indicated in a record, the record being located based on an identifier associated with the communication device.

39. The system of claim 38 wherein the communication device includes a telephonic device, and the identifier includes a telephone number.

40. The system of claim 39 further comprising a switching facility for receiving signals in establishing the communication connection, wherein the signals contain data concerning the telephone number.

41. The system of claim 40 wherein the data includes an ANI.

42. The system of claim 36 wherein the selected manner includes automatically incorporating the desired information into the data source.

43. The system of claim 36 wherein the selected manner includes delaying an incorporation of the desired information into the data source until the user causes a selected signal to be transmitted through the communication connection, indicating an initiation of the incorporation.

44. The system of claim 43 wherein the selected signal includes a voice command.

45. The system of claim 43 wherein the selected signal is generated using a telephonic device.

46. The system of claim 45 wherein the selected signal includes a DTMF signal.

47. The system of claim 36 wherein the desired information includes a telephone number of a desired party.

48. The system of claim 47 further comprising a switching facility for initiating a communication call through a second communication connection to a communication device associated with the telephone number.

49. The system of claim 47 wherein the selected manner includes offering an incorporation of the desired information into the data source after the communication call is successfully completed.

50. The system of claim 47 wherein the selected manner includes offering an incorporation of the desired information into the data source when a busy condition of the second communication connection is determined.

51. The system of claim 47 wherein the selected manner includes offering an incorporation of the desired information into the data source when a ring-no-answer condition of the second communication connection is determined.

52. The system of claim 47 wherein the selected manner includes offering an incorporation of the desired information into the data source when it is determined that the second communication connection has a communication problem.
